(19) United States
(12) Patent Application Publication
(10) Pub. No.: US 2008/0276534 A1
(43) Pub. Date: Nov. 13, 2008

(54) Devices and methods for growing plants by measuring liquid consumption

(75) Inventors: W. Michael Bissonnette, Boulder, CO (US); John Thompson, Niwot, CO (US); Sylvia Bernstein, Boulder, CO (US); Laura L. Conley, Boulder, CO (US); Carson Payne, Niwot, CO (US); Robert E. Wainwright, Napanee (CA); Curt Morgan, Huntington Beach, CA (US); Terry Robertson, Boulder, CO (US); Brian McGee, Firestone, CO (US)

Correspondence Address: VENABLE LLP, P.O. BOX 34385, WASHINGTON, DC, 20043-9998, US

(73) Assignee: AeroGrow International, Inc., Boulder, CO (US)

(21) Appl. No.: 12/002,543

(22) Filed: Dec. 17, 2007

Related U.S. Application Data
(63) Continuation-in-part of application No. 11/321,368, filed on Dec. 28, 2005.
(60) Provisional application No. 60/640,704, filed on Dec. 30, 2004.

(51) Int. Cl. A01G 31/02; A01G 31/00

(52) U.S. Cl. 47/62 R; 47/59 R

(57) ABSTRACT

This invention provides adaptive growth technology, hydroponic and aeroponic gardens with adaptive growth technology, and methods for growing a plant or germinating a seed in with adaptive growth technology. An apparatus of this invention includes a vessel, a growing surface, a light source, a liquid measurement device, a controller in communication with the measurement device and a time that calculate the rate of consumption of the liquid in the vessel by seeds or plants and that adjust the liquid delivery rate, the liquid quality, the nutrient delivery rate, the nutrient quality, the photoradiation delivery rate, and/or the photoradiation quality based on the calculated rate of liquid usage. In an embodiment, the steps are performed automatically without human intervention.

### CROSS-REFERENCE TO RELATED APPLICATIONS

This application is a Continuation-in-Part of application Ser. No. 11/321,368, filed Dec. 28, 2005, which claims priority under 35 U.S.C. 119(e) to Provisional patent application 60/640,704, filed Dec. 30, 2004, which is hereby incorporated by reference in its entirety to the extent not inconsistent with the disclosure herein.

### FIELD OF THE INVENTION

This invention is in the fields of plant agriculture, home gardening, indoor gardening, and hydroponics.

### BACKGROUND

It is known in the art that plants use different quantities of water during different stages of growth. A plant's water use changes with a predictable pattern from germination to maturity (Soil, Water and Plant Characteristics Important to Irrigation, EB-66, February 1996, North Dakota State University Cooperative Extension Service). For example, plants use little water for germination and emergence, more water during vegetative growth, even more water during the reproductive growth stages, and less water again at maturity and senescence. Plants also use less water after cuttings.

In plant cultivation, the delivery rate of nutrients and water to the roots and the delivery rate of photoradiation to the shoots/flowers are known to impact the growth rate and health of the plant. For optimal growth, the delivery rates of nutrients, water, and photoradiation should vary as the plant grows. Adjusting the nutrient, water, and/or photoradiation as a function of plant growth allows an optimal environment to be created.

Knowledge of plant water use patterns during different growth stages have been used to influence irrigation system design and management. Soil moisture monitoring has been used for determining when to irrigate, determining how much irrigation water to apply, avoiding over- and under-irrigating, and correlating moisture/water use with vegetative growth (http://www.earthsystemssolutions.com/assets/monitoring.htm, Earth Systems Solutions, Lompoc, Calif. USA).

Various methods are known in the art for measuring water use by plants, including using irrigation/evaporation tubs and soil moisture probes and by monitoring the weight loss of intact plants grown in pots. “An electronic photometer for studying plant water use in real time” (PlantStress.com) describes a Micro-Electronic Potometer (MEP) for accurate real-time monitoring of plant water use. The instrument is described as being built from six units each comprising two parallel vessels joined by a tube; one vessel accommodating a hydroponically grown plant; the other containing a float connected to a high-accuracy linear variable differential transducer (LVDT).

Various methods are known in the art for predicting plant growth rates including light reflection and weather data. Spectroradiometers have been used to measure light reflected from plants to predict growth rates (Apogee Instruments Inc., Logan, Utah USA, http://www.stellarnet.us/agriculture.htm). Melon Man: A simple cantaloupe phenology model (USDA Agricultural Research Service) describes a project for developing methodologies using standard weather data to predict leaf appearance, crop developmental stages and final harvest date. The proposal describes plans for cantaloupe growers to use the model to accurately predict harvest dates as well as provide a tool for managing crop growth stage dependent applications of fertilizer, pesticides, and irrigation, allowing growers to make management decisions without visual inspection of crops.

Central control devices are useful in agriculture. U.S. Pat. No. 6,314,675 describes a method for managing an air culture system for plants using a central control unit. U.S. Pat. No. 5,525,505, U.S. Pat. No. 5,558,984, and U.S. Pat. No. 5,597,731 describe methods for controlling and regulating the flow and delivery of a liquid plant growth media automatically by a central control means including a microprocessor. These central control units receive data on the cultivation system, including temperature, humidity, and electrical conductivity (E.C.) of the nutrient solution. The content and delivery of the nutrient solution is described as then modified automatically by the central control unit.

No devices or methods for measuring and using measured water usage to determine or adjust the quantity and/or quality of nutrient and/or photoradiation delivery have been known in the art.

### SUMMARY OF THE INVENTION

This invention provides Adaptive Growth Technology, devices and methods for modifying plant growth regimes based on the liquid usage rate and/or the nutrient usage rate of the plant.

This invention provides a hydroponic or aeroponic garden apparatus, comprising: a vessel having a closed lower portion for storing a liquid; a growing surface covering the vessel, the growing surface adapted to support at least one seed cartridge containing a seed or a plant; a light source positioned above the growing surface and adapted to project light toward the seed cartridge; a measurement device located in or near the vessel and adapted to measure the level of the liquid; and a controller in communication with the measurement device and the timer, the controller adapted to calculate a rate of consumption of the liquid in the vessel, and perform at least one predetermined function based on the rate of consumption, wherein the at least one predetermined function selected from the group consisting of: adjusting a timing cycle of the light source; adding a nutrient to the liquid; and triggering an add-nutrient indicator.

This invention provides a method of growing a plant or germinating a seed in a hydroponic or aeroponic garden apparatus, comprising: delivering a liquid to the plant or seed at a liquid delivery rate, the liquid exhibiting a liquid quality; delivering a nutrient to the plant or seed at a nutrient delivery rate, the nutrient exhibiting a nutrient quality; delivering photoradiation to the plant or seed at a photoradiation delivery rate, the photoradiation exhibiting a photoradiation quality; calculating a rate of liquid usage by the plant or seed in the hydroponic or aeroponic garden apparatus; and adjusting at least one of the liquid delivery rate, the liquid quality, the nutrient delivery rate, the nutrient quality, the photoradiation delivery rate, and the photoradiation quality based on the calculated rate of liquid usage.

### BRIEF DESCRIPTION OF THE DRAWINGS

FIG. 1 is an illustration showing a front view of a hydroponic garden apparatus of this invention.

FIG. 2 is an illustration showing a side view of a hydroponic garden apparatus of this invention.

FIGS. 3A and 3B are illustrations showing user interfaces of hydroponic garden apparati of this invention.

FIGS. 4A and 4B are illustrations showing a garden apparatus of this invention and a seed cartridge.

FIG. 5 is an illustration showing a lateral cross-section of a garden of this invention showing a liquid level measurement device float and a linear hall effect sensor.

FIG. 6A shows the illustration in FIG. 5 with a box marking the blow up illustration shown in FIG. 6B with the measurement device components.

FIG. 7 is an illustration showing the internal components of a garden apparatus of this invention showing the control board, power, board, and pump.

FIG. 8 is an illustration showing internal components of an alternative garden apparatus of this invention with a plurality of magnetic reed switches.

FIG. 9 is an illustration showing a schematic of inputs and outputs of a garden apparatus of this invention.

FIG. 10 is an illustration showing an electrical diagram of a garden apparatus control board of this invention, showing the linear hall effect sensor and crystal timer.

### DETAILED DESCRIPTION OF THE INVENTION

As is used in the art and as used herein, a “vessel” is able to contain a liquid and optionally has a bottom wall and/or one or more side walls. A side wall has a vertical component. Preferably the vessel is not permeable to photoradiation that would interfere with plant growth or would promote growth of unwanted organisms such as algae.

Vessels of this invention are removably coverable by growing surface cover that has at least one plant opening receptacle for removably suspending a plant. Preferably covers are not permeable to photoradiation that would interfere with plant growth or would promote growth of unwanted organisms such as algae. Preferably the devices of this invention are also not permeable to liquids except at the plant opening(s) and any other opening functioning in liquid or gas transfer, such as a liquid fill inlet or outlet or oxygen inlet.

As used herein, “hydroponic” refers to plant growing techniques that do not use soil. As used herein, “optimal growth” refers to plant growth that is optimized to achieve a selected set of characteristics, e.g., fruit harvest, root harvest, leaf harvest, flower production and/or size, and longevity. The systems and devices of this invention provide optimal plant growth.

As used in the art and as used herein, “nutrients” refers to atoms and molecules in an available form necessary for plant growth in addition to oxygen, hydrogen, and water including calcium, magnesium, sodium, potassium, nitrogen, phosphorus, sulfur, chlorine, iron, manganese, copper, zinc, boron, and molybdenum. Nutrient formulations can be “complete” an contain all atoms and molecules necessary for about optimal growth in an appropriate ratio for the plant to be grown. Nutrient formulations and recipes are known in the art (see, for example, Resh H. M (2001) Hydroponic Food Production, Sixth Addition, Woodbridge Press Publishing Company, Santa Barbara, Calif., USA). It is known in the art that a liquid that contacts a plant, e.g., liquid used to supply nutrients to a plant, is preferably within a particular pH range. Optimal pH ranges for a variety of plants are known in the art. It is known in the art that a liquid that contacts a plant, e.g., liquid used to supply nutrients to a plant, is preferably within a particular pH range. Optimal pH ranges for a variety of plants are known in the art. Preferably the compositions and methods of this invention maintain the pH of liquids within the optimal pH ranges.

As used herein, “photoradiation” refers to wavelengths of light of sufficient quantity and quality that allow a plant to grow, as is known in the art. It is known in the art which quantities and wavelengths of photoradiation are preferred for many plants.

The term “growing a plant” as used in herein refers to the process which takes place when appropriate conditions such as water, photoradiation, gas containing oxygen and carbon dioxide, and nutrients are provided to a plant tissue, whether a seed, a cutting, transplant, bulb, tuber, runner, or a plant having roots, resulting in an increase in the mass of plant tissue. The term “cutting” as used herein refers to plant tissue with or without roots taken from an already existing plant.

The term “germinating a seed into a plant” as used herein refers to the process which takers place when appropriate conditions such as water, photoradiation, gas containing oxygen, carbon dioxide and optionally nutrients are provided to the seed, resulting in the emergence of a plant embryo from the seed.

The term “intermittent delivering” as used herein refers to a delivery schedule which includes periods of time when delivery is not taking place. The term “continuous delivering” as used herein refers to a delivery schedule which does not include a period of time when delivery is not taking place.

The term “seed cartridge” as used herein refers to a structure for supporting a plant or seed in a hydroponic garden. Optionally a seed cartridge also contains a growing medium, label, and/or grow dome.

The components illustrated in the drawings are numbered as shown below.

| Number | Item |
|---|---|
| 3 | growing surface |
| 4 | seed cartridge opening |
| 12 | vessel |
| 110 | seed |
| 140 | smart garden display panel/user interface |
| 141 | transformer |
| 142 | circuit board power |
| 143 | circuit board controller |
| 144 | plant type select |
| 145 | add nutrients reset button |
| 146 | add nutrients indicator 1 |
| 147 | add water flashing signal |
| 148 | timing cycle selection name that lights up |
| 149 | photoradiation cycle override button |
| 150 | add nutrients indicator 2 |
| 180 | seed cartridge |
| 220 | light source |
| 221 | nutrient chamber |
| 222 | nutrient dispenser |
| 223 | light bulb |
| 224 | liquid measurement device float |
| 225 | liquid measurement device linear hall effect sensor |
| 228 | pump |
| 229 | timer |
| 230 | indicators |
| 231 | instruction for predetermined function |
| 232 | base |
| 233 | magnetic reed switch |

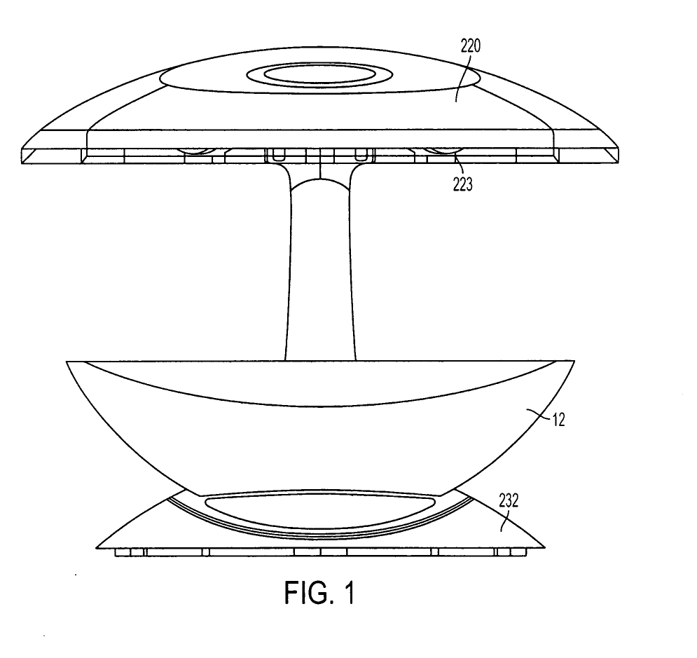

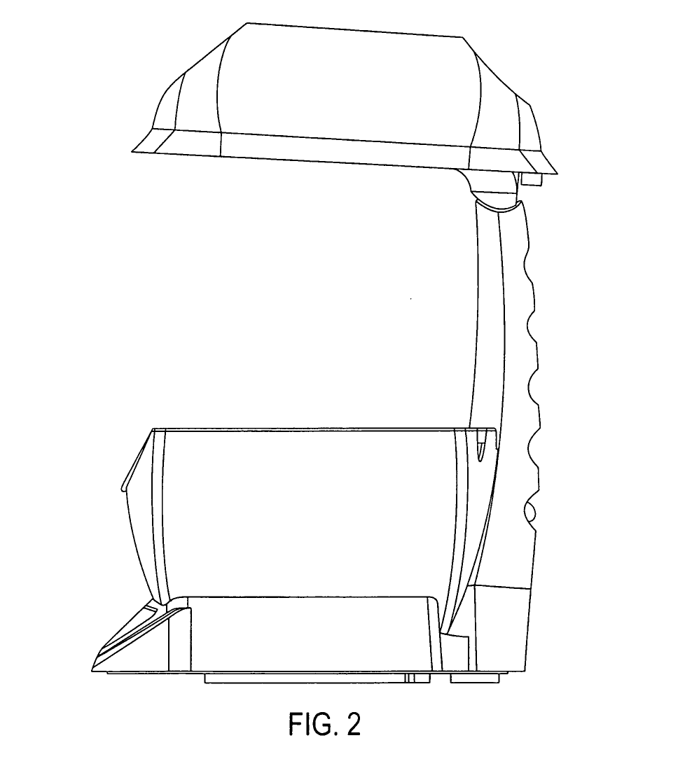

FIG. 1 shows an aeroponic/hydroponic garden apparatus of this invention, showing the vessel 12, light hood and source 220, light bulb 223, and garden base 232. The vessel contains a float that rises and falls with the level of the liquid in the vessel and the linear hall effect sensor detects the height of the float. Knowing the vessel form, the quantity of liquid consumed by a growing plant can be determined using the change in height of the float as detected by the hall effect sensor. FIG. 2 shows this garden apparatus from the side.

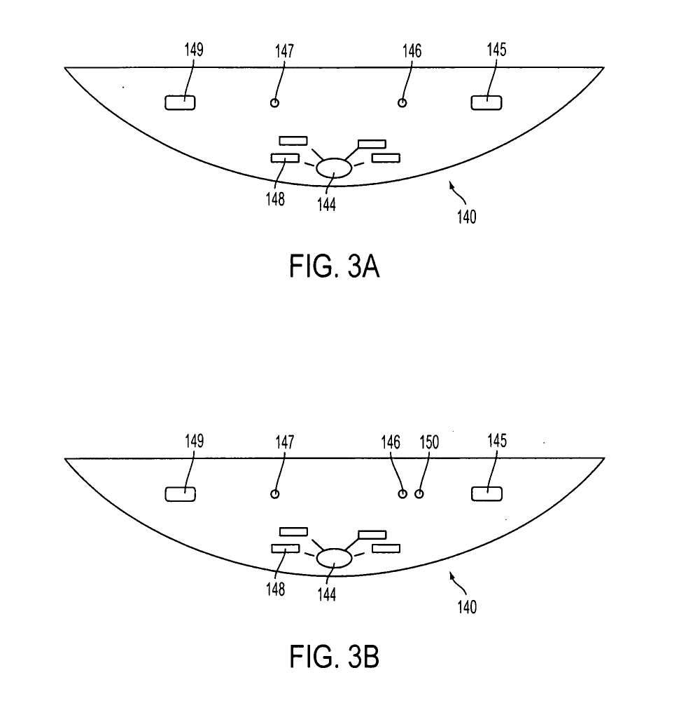

FIG. 3 shows two versions of control panels or user interfaces. The FIG. 3A user interface has one add nutrient indicator 146. FIG. 3B user interface has two add nutrient indicators 146 and 150. There could also be a display indicating how many and which type of nutrients to add.

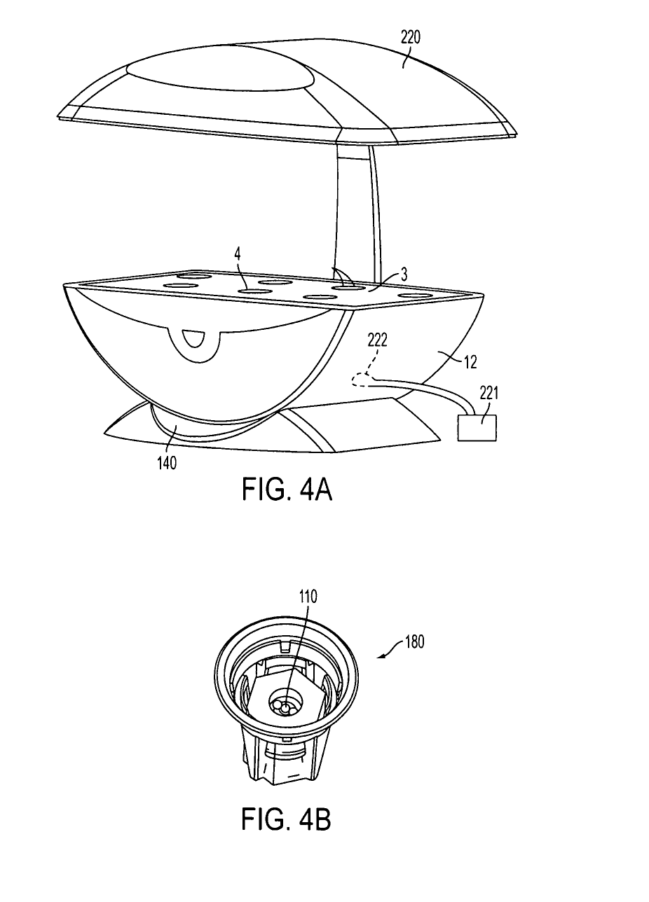

FIG. 4A shows a garden apparatus of this invention. This apparatus has a nutrient chamber 221 and dispenser 222 that adds nutrients to the liquid in the vessel 12 without human intervention. The light hood 220, growing surface 3, and growing surface opening 4 are shown. FIG. 4b shows an example of a seed cartridge 180, with visible seeds 110.

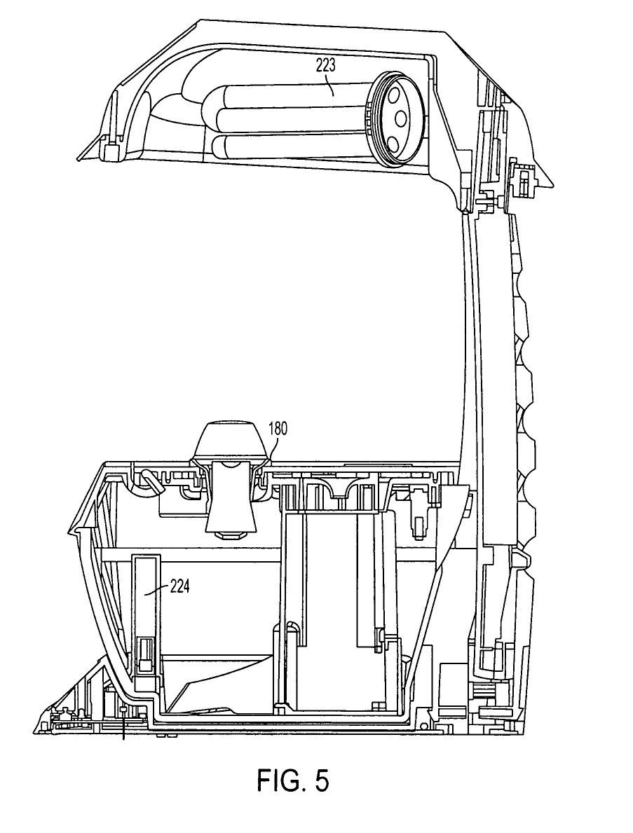

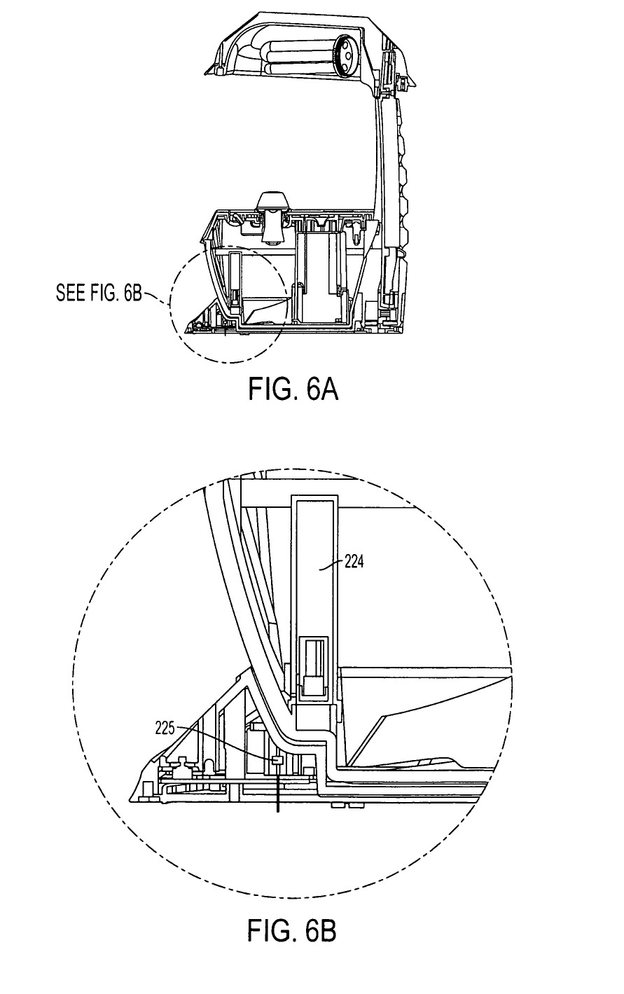

FIG. 5 shows a cross-section of the garden apparatus in FIG. 1 with a seed cartridge 180. The liquid measurement device float 224 is visible. This garden apparatus is also shown in FIG. 6A with a box showing the blow-up view in FIG. 6B. The tube housing the float is marked as well as the linear hall effect sensor 225.

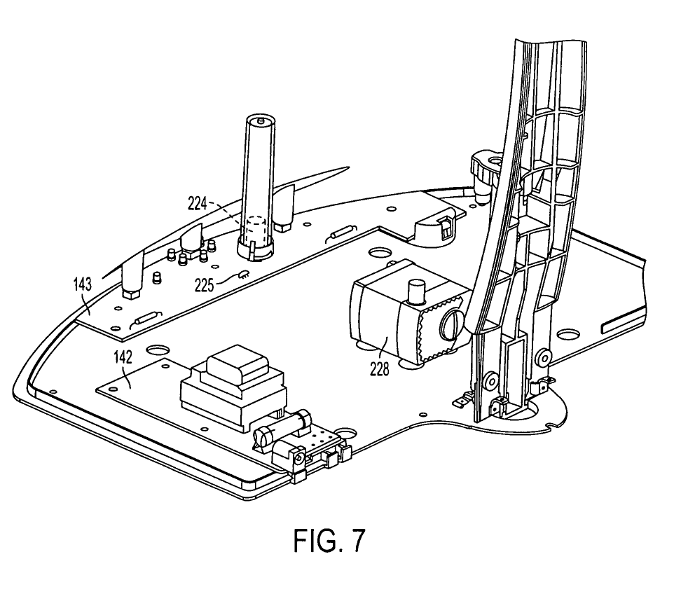

The float 224 itself is labeled in FIG. 7. FIG. 7 shows a portion of the arm supporting the light hood, the internal elements of the apparatus inside the base, and some of the elements that are in the vessel or suspended in the vessel from the growing surface, but the vessel is not shown. The power board 142, control board 143, linear hall effect sensor 225 in the base are shown. The pump 228 that is suspended from the growing surface (when the vessel and growing surface are set in the base, the arm which is electrically connected to the base makes electrical contact with the growing surface and pump) is shown. It is connected to a tube (not shown) through which liquid is pumped to the seed cartridges. The float 224 is in a housing within the vessel (not shown), in proximity to the linear hall effect sensor 225 which is sensitive to the Gaussian magnetic field from the magnet in the float.

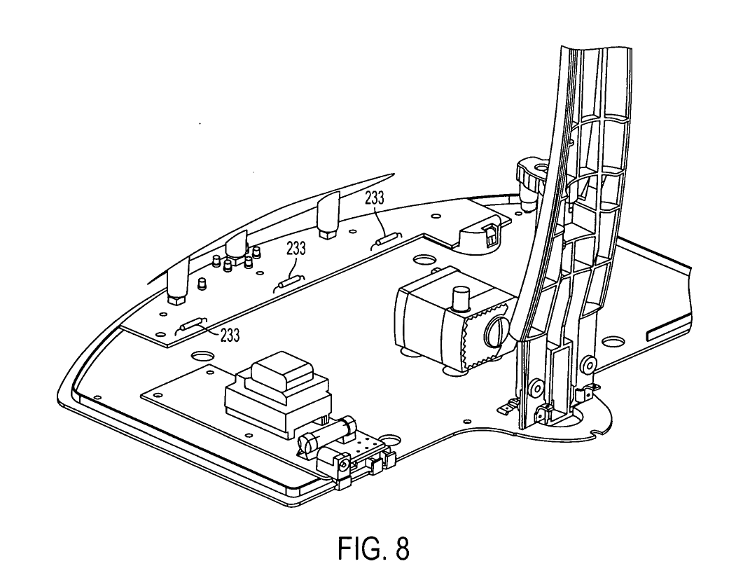

FIG. 8 shows a different version in which three magnetic reed switches are positioned to detect magnetic fields from three magnetic floats (not shown).

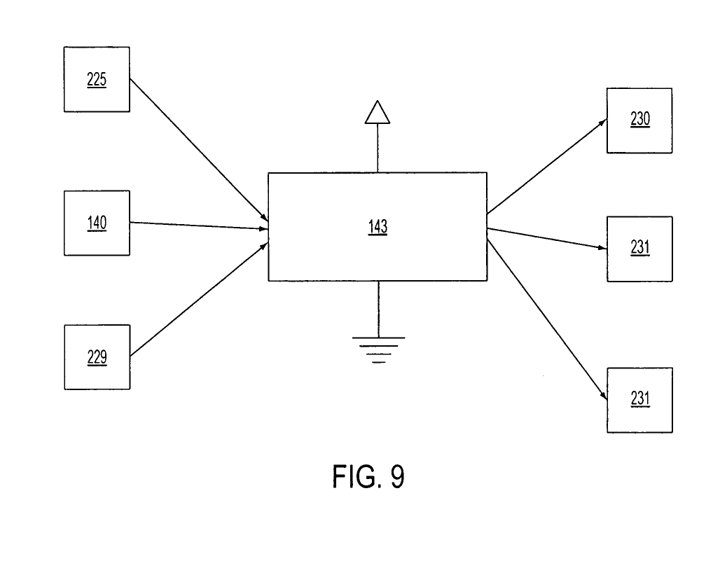

FIG. 9 shows data received by the microcontroller 143 from the user interface 140, linear hall effect sensor 225 and the timer 229 and data sent by the microcontroller to the user interface indicators 230, and pre-determined functions 231 such as change light schedule to on 16 hours and off 8 hours or pump on 24 hours.

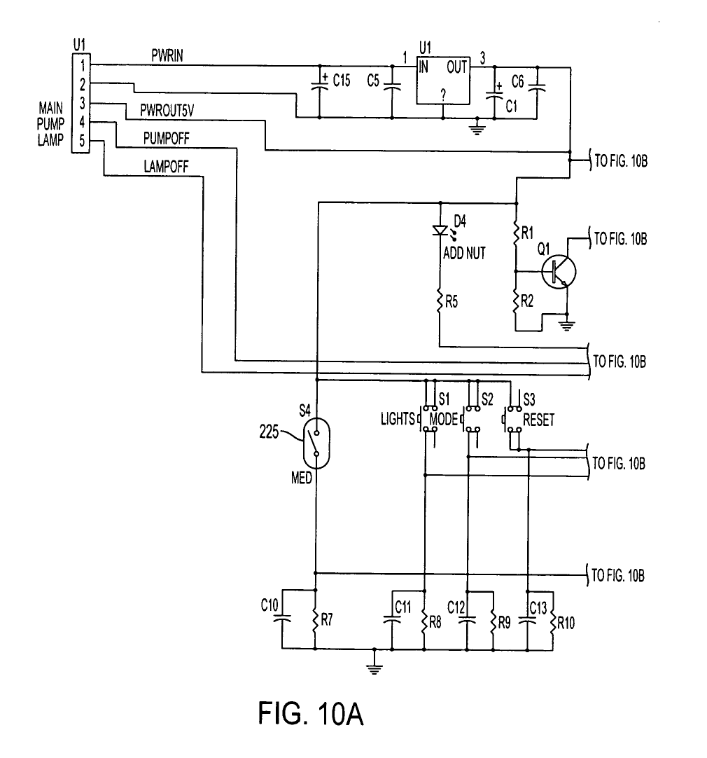

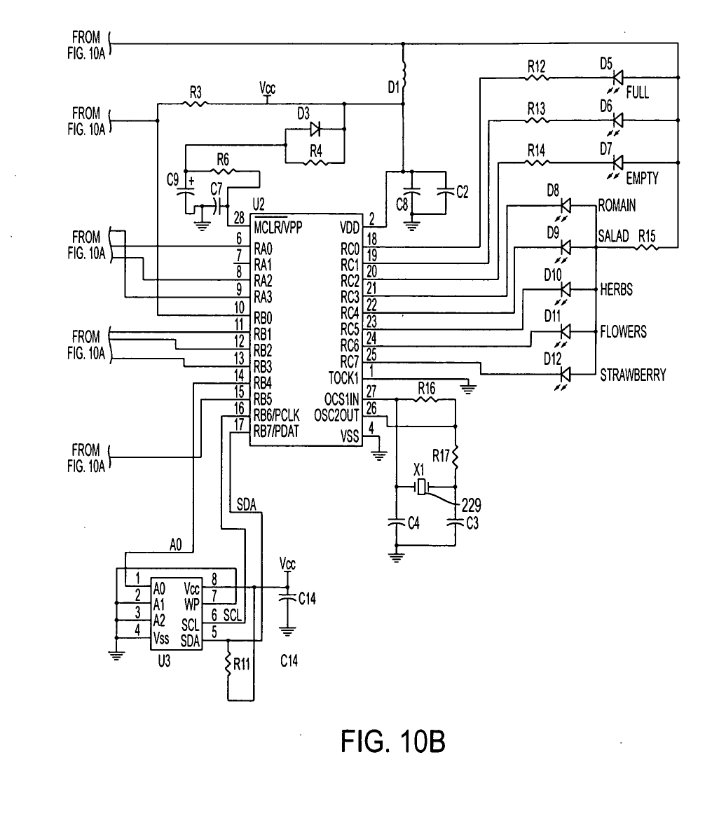

FIG. 10 shows the electrical circuit of the control board including the oscillating crystal timer 229 and the linear hall effect sensor 225.

Gardening or hydroponics systems in which liquid level can be measured and/or in which liquid usage rate can be measured are useful in the practice of this invention.

Water usage is an important indicator of plant growth, health, nutrient, and light requirements, therefore it is desirable to track water usage in order to determine how to best deliver nutrients, liquid, and/or photoradiation to the plant.

This invention provides Adaptive Growth Technology, devices and methods for modifying plant growth regimes based on the liquid usage rate and/or the nutrient usage rate of the plant. Adaptive Growth Technology provided by this invention is useful for optimizing and improving plant growth, speeding growth and increasing yields, compared to not using adaptive growth technology.

This invention provides a hydroponic or aeroponic garden apparatus, comprising: a vessel having a closed lower portion for storing a liquid; a growing surface covering the vessel, the growing surface adapted to support at least one seed cartridge containing a seed or a plant; a light source positioned above the growing surface and adapted to project light toward the seed cartridge; a measurement device located in or near the vessel and adapted to measure the level of the liquid; and a controller in communication with the measurement device and the timer, the controller adapted to calculate a rate of consumption of the liquid in the vessel, and perform at least one predetermined function based on the rate of consumption, wherein the at least one predetermined function selected from the group consisting of: adjusting a timing cycle of the light source; adding a nutrient to the liquid; and triggering an add-nutrient indicator.

In an embodiment, the garden apparatus further comprises a pump adapted to deliver the liquid from the vessel to the at least one seed cartridge, wherein the controller is adapted to adjust a flow rate of the pump based on the rate of consumption.

In an embodiment, the add-nutrient indicator indicates a type and/or amount of nutrient to add.

In an embodiment, the garden apparatus further comprises a nutrient chamber for holding at least one nutrient; and a nutrient dispenser adapted to dispense the at least one nutrient into the liquid; wherein the controller is adapted to adjust a flow rate of the nutrient dispenser based on the rate of consumption of the liquid.

In an embodiment, the measurement device is selected from the group consisting of: linear hall effect sensor, a plurality of hall effect sensors, a float connected to a mechanical encoder, a float connected to an optical encoder, an infrared device, a plurality of pairs of a magnetic floatation device and magnetic reed switch.

In an embodiment, the controller is selected from the group consisting of: microcontroller, central processing unit,

In an embodiment, the garden apparatus further comprises a memory in communication with the controller.

In an embodiment, the memory is selected from the group consisting of: an electrically erasable programmable read-only memory, electrically programmable read-only memory, flash memory, memory built in to the micro-controller.

In an embodiment, the garden apparatus further comprises a look-up table stored in the memory, wherein the controller determines which predetermined function to perform by comparing the calculated rate of consumption to the look-up table.

In an embodiment, the garden apparatus further comprises an algorithm programmed into the controller, wherein the controller determines which predetermined function to perform by applying the algorithm to the calculated rate of consumption.

In an embodiment, the garden apparatus further comprises a timer, wherein the controller is adapted to calculate the rate of consumption based on data from the timer and the measurement device. In an embodiment, the timer is an oscillating crystal.

This invention provides a method of growing a plant or germinating a seed in a hydroponic or aeroponic garden apparatus, comprising: delivering a liquid to the plant or seed at a liquid delivery rate, the liquid exhibiting a liquid quality; delivering a nutrient to the plant or seed at a nutrient delivery rate, the nutrient exhibiting a nutrient quality; delivering photoradiation to the plant or seed at a photoradiation delivery rate, the photoradiation exhibiting a photoradiation quality; calculating a rate of liquid usage by the plant or seed in the hydroponic or aeroponic garden apparatus; and adjusting at least one of the liquid delivery rate, the liquid quality, the nutrient delivery rate, the nutrient quality, the photoradiation delivery rate, and the photoradiation quality based on the calculated rate of liquid usage.

In an embodiment, calculating the rate of liquid usage by the plant or seed comprises: measuring a first liquid level in the hydroponic or aeroponic garden apparatus at a first time point; measuring a second liquid level in the hydroponic or aeroponic garden apparatus at a second time point; calculating an elapsed time between the first time point and the second time point; calculating an amount of consumed liquid by subtracting the first liquid level from the second liquid level; and dividing the amount of consumed liquid by the elapsed time.

In an embodiment, the method further comprises comparing the rate of liquid usage to a look-up table. In an embodiment, the method further comprises applying an algorithm to the rate of liquid usage. In an embodiment, delivering the liquid to the plant or seed comprises pumping the liquid from a storage vessel to the plant or seed. In an embodiment, delivering a nutrient to the plant or seed comprises providing the nutrient in the liquid. In an embodiment, delivering photoradiation to the plant or seed comprises projecting light or photoradiation onto the plant or seed from a bulb.

In an embodiment, adjusting the liquid delivery rate comprises at least one of increasing the liquid delivery rate, decreasing the liquid delivery rate, increasing flow rate of said liquid, decreasing a flow rate of said liquid, increasing the on/off ratio wherein said liquid is delivered intermittently, decreasing the on/off ratio wherein said liquid is delivered intermittently, switching from continuous to intermittent delivery of said liquid, switching from intermittent to continuous delivery of said liquid, and increasing from on for less than or about 15 hours of every 24 hours to on for more than or about 17 hours of every 24 hours.

In an embodiment, adjusting the nutrient delivery rate comprises at least one of decreasing the time between intermittently adding a nutrient molecule or atom to said liquid, increasing the time between intermittently adding a nutrient molecule or atom to said liquid, increasing from about 1.5 grams complete nutrient for about every 14 cups every 2 weeks to about 3 grams complete nutrient for about every 14 cups every 2 weeks.

In an embodiment, adjusting the nutrient quality comprises at least one of decreasing a nutrient atom or molecule, increasing a nutrient atom or molecule, adding a new nutrient or molecule, removing a nutrient or molecule, increasing calcium, increasing magnesium, decreasing nitrogen, increasing nitrogen, increasing potassium, increasing phosphorus, and modifying the nitrogen/phosphorus/potassium ratio.

In an embodiment, adjusting the photoradiation rate comprises at least one of increasing the on/off ratio wherein said photoradiation is delivered intermittently, decreasing the on/off ratio wherein said photoradiation is delivered intermittently, increasing the distance between said seed or plant and said bulb, and decreasing the distance between said seed or plant and said bulb.

In an embodiment, adjusting the photoradiation quality comprises at least one of replacing an old bulb with a new bulb.

In an embodiment, calculating a rate of liquid usage by the plant or seed in the hydroponic or aeroponic garden apparatus and adjusting at least one of the liquid delivery rate, the liquid quality, the nutrient delivery rate, the nutrient quality, the photoradiation delivery rate, and the photoradiation quality based on the calculated rate of liquid usage are performed automatically without human intervention.

This invention provides smart garden devices for gardening systems comprising: means for measuring the quantity of liquid in the system; and means for setting a characteristic of the system; the smart garden device comprising: means for receiving electricity; means for sending to and/or receiving data from the gardening or hydroponics system; means for measuring time elapsed; means for calculating liquid usage rate by the system; and means for modifying the characteristic of the system by utilizing the liquid usage rate.

This invention provides smart garden devices for gardening systems comprising: means for measuring the quantity of liquid in the system; and means for setting a characteristic of the system; means for measuring time elapsed; the smart garden device comprising: means for receiving electricity; means for sending to and/or receiving data from the gardening or hydroponics system; means for calculating liquid usage rate by the system; and means for modifying the characteristic of the system by utilizing the liquid usage rate.

The means for measuring time elapsed an/or the means for measuring the quantity of liquid in the system can be part of the gardening or hydroponics system or part of the smart garden device.

This invention provides smart garden devices for gardening or hydroponics systems comprising: means for delivering a liquid to a plant or a seed germinating into a plant at a liquid delivery rate; and means for measuring the quantity of the liquid in the system; the smart garden device comprising: means for receiving electricity; means for sending to and/or receiving data from the gardening or hydroponics system; means for measuring time elapsed; means for calculating the liquid usage rate by the gardening or hydroponics system; and means for modifying the liquid delivery rate by a method utilizing the liquid usage rate.

This invention provides methods for making the devices of this invention and provides methods for using the devices of this invention.

In an embodiment, the gardening or hydroponics system further comprises: means for selecting a quality of liquid delivered to the plant; and the smart garden device further comprises: means for modifying the liquid delivery quality by a method utilizing the liquid usage rate.

In an embodiment, the gardening or hydroponics system further comprises: means for displaying the status of a requirement to add at least one nutrient at a requirement to add nutrients rate; means for receiving nutrients; and means for delivering the nutrient to a plant at a nutrient delivery rate; and the smart garden device further comprises: means for modifying the nutrient delivery rate or the requirement to add nutrient rate, by a method utilizing the liquid usage rate.

In an embodiment, the gardening or hydroponics system further comprises: means for displaying the quantity and/or quality of nutrients to add; and the smart garden device further comprises: means for modifying the display of the quantity and/or quality of nutrient to add by a method utilizing the liquid usage rate. In an embodiment, the system further comprises a means for displaying the quantity and/or quality of nutrients to add at a display rate; and the smart garden device further comprises a means for modifying the display rate by a method utilizing the liquid usage rate.

In an embodiment, the gardening or hydroponics system further comprises: means for delivering photoradiation to the plant; and the smart garden device further comprises: means for modifying the photoradiation delivery rate by a method utilizing the liquid usage rate.

In an embodiment, the gardening or hydroponics system further comprises: means for selecting quality of photoradiation delivered to the plant; the smart garden device further comprises: means for modifying the photoradiation delivered quality to the plant by a method utilizing the liquid usage rate.

In an embodiment, the device comprises all of the above means. In an embodiment, modifying is increasing or decreasing. In an embodiment, the smart garden device further comprises a means for comparing a first liquid usage rate to a second liquid usage rate.

In an embodiment, the means for measuring the quantity of liquid in the system comprises a device is selected from the group consisting of: floatation devices, magnetic reed switch devices, electric current devices, proximity switch devices, infrared devices, sonic devices, hall effect sensor devices, photocell devices, and photographic devices.

In an embodiment, calculating the liquid usage rate comprises: measuring a first quantity of liquid in the system at a first time; measuring a second quantity of liquid in the system at a second time wherein the second time is before additional liquid is added to the system; subtracting the second quantity of liquid from the first quantity of liquid, and then dividing by the time elapsed between the first time and the second time.

In an embodiment, the means for measuring the quantity of the liquid in the system comprises a magnetic floatation device and a magnetic reed switch. In an embodiment, the smart garden device comprises three magnetic floatation devices and three magnetic reed switches.

In an embodiment, the gardening or hydroponics device comprises a means for maximally containing between about 14 cups and about 17 cups of liquid, wherein the first magnetic reed switch is activated by the first magnetic floatation device when the gardening or hydroponics system contains between about 10 cups to about the maximum liquid level, wherein the second magnetic reed switch is activated by the second magnetic floatation device when the gardening or hydroponics system contains between about 7 cups and about 10 cups, and wherein the third magnetic reed switch is activated by the third magnetic floatation device when the gardening or hydroponics system contains less than about 7 cups. In an embodiment, the gardening or hydroponics device comprises a means for maximally containing an Amount A of liquid and a means for detecting when the device contains about Amount A of liquid and a means for detecting when the garden contains a selected portion of Amount A, such as about ⅔ of Amount A. In an embodiment, the gardening or hydroponics device comprises a means for maximally containing an amount B of liquid, wherein the first magnetic reed switch is activated by the first magnetic floatation device when the gardening or hydroponics system contains between about ⅔ Amount B to about the maximum liquid level (Amount B), wherein the second magnetic reed switch is activated by the second magnetic floatation device when the gardening or hydroponics system contains between about ½ Amount B and about ⅔ Amount B, and wherein the third magnetic reed switch is activated by the third magnetic floatation device when the gardening or hydroponics system contains less than about ½ B. Other amounts, in addition to ½ B, ⅔ B, and B, are useful in the practice of this invention.

In an embodiment, this invention provides a smart garden device wherein said means for measuring the quantity of said liquid in said system comprises three magnetic floatation devices and three magnetic reed switches, wherein said gardening or hydroponics device comprises a means for containing a maximum amount of liquid, wherein said first magnetic reed switch is activated by said first magnetic floatation device when said gardening or hydroponics system contains between a larger liquid fraction and about the maximum amount of liquid, wherein said second magnetic reed switch is activated by said second magnetic floatation device when said gardening or hydroponics system contains between a smaller liquid fraction and about the larger liquid fraction, and wherein said third magnetic reed switch is activated by said third magnetic floatation device when said gardening or hydroponics system contains less than about said smaller liquid fraction. The larger amount and smaller amount are fractions of the maximum amount, and the smaller amount is less than the larger amount. The larger amount can be any selected measurable amount that is less than the maximum amount of liquid, and the smaller amount can be any selected measurable amount that is less than the larger amount. In an embodiment, the larger amount is between about half the maximum amount and the maximum amount and the smaller amount is between about 5% of the maximum amount and about half the maximum amount.

In an embodiment, the first time is about when the second reed switch is activated which is about when the first reed switch is deactivated or about when the first reed switch is deactivated and the second time is about when the third reed switch is activated or about when the second switch is deactivated which is about when the third reed switch is activated.

In an embodiment, the first time is about when the third reed switch is deactivated or when the second reed switch is activated which is about when the third reed switch is deactivated and the second time is about when the third reed switch is secondly activated or about when the second reed switch is activated which is about when the third reed switch is deactivated.

In an embodiment, the liquid usage rate is first greater than about 3 cups per about 7 days, when the liquid delivery rate is increased. In an embodiment, the liquid usage rate is first greater than about 3 cups per 3 days, when the increased liquid delivery rate is secondly increased. In an embodiment, the liquid usage rate is first greater than about 3 cups per 1.5 days, when the further increased liquid delivery rate is thirdly increased.

In an embodiment, in any device of this invention, when the liquid usage rate is first greater than a rate selected from the group consisting of: about 3 cups per about 7 days, about 3 cups per about 3 days, about 3 cups per about 1.5 days, and about 3 cups per about ½ a day, a characteristic selected from the group consisting of: liquid delivery rate, liquid delivery quality, nutrient delivery rate, requirement to add nutrients rate, display of the quantity and/or quality of nutrients to add, photoradiation delivery rate, and photoradiation delivery quality, is modified.

In an embodiment, the smart garden device further comprises a means for sending data to or receiving data from an external preprogrammed or a programmable storage device directly or through the internet. In an embodiment, the smart garden device further comprises a device selected from the set consisting of: preprogrammed storage devices, programmable storage devices, circuit boards, and computer chips. In an embodiment, the smart garden device further comprises means for determining, receiving, sending, storing, and/or processing data. In an embodiment, the smart garden device further comprises a means for storing liquid usage rate data.

In an embodiment, the gardening or hydroponics system comprises the smart garden device or the smart garden device fits in a chamber of the gardening or hydroponics device. This invention provides gardening or hydroponics systems comprising the smart garden devices of this invention.

In an embodiment, the liquid is an aqueous plant nutrient solution.

In an embodiment, the gardening or hydroponics system further comprises a pump for delivering the liquid and modifying the liquid delivery rate comprises modifying the pump on/off frequency or modifying the pump flow rate while on.

This invention provides methods for growing a plant comprising: providing the gardening or hydroponics system wherein the gardening or hydroponics system is growing a plant or germinating a plant from a seed and also providing the smart garden device, both of any device of this invention; measuring a first quantity of liquid at a first time in the gardening or hydroponics system; allowing time to elapse; measuring a second quantity of liquid at a second time in the gardening or hydroponics system; measuring the time elapsed; calculating the liquid usage rate; and modifying one or more characteristic selected from the group consisting of: liquid quality, liquid delivery rate, plant nutrient quality, plant nutrient delivery rate, photoradiation quality, and photoradiation delivery rate, by a method utilizing the liquid usage rate.

This invention provides methods for growing a plant or germinating a seed into a plant comprising: providing the plant or the seed; providing a liquid having a liquid delivery quality; providing at least one plant nutrient having a plant nutrient quality; providing photoradiation having photoradiation quality; delivering the liquid to the plant at a liquid delivery rate; delivering the at least one plant nutrient at a plant nutrient delivery rate; delivering the photoradiation; measuring the liquid usage rate of the plant; modifying one or more characteristic selected from the group consisting of: liquid quality, liquid delivery rate, plant nutrient quality, plant nutrient delivery rate, photoradiation quality, and photoradiation delivery rate, by a method utilizing the liquid usage rate.

In an embodiment, the plant is germinated or the seed is grown within a gardening or hydroponics system.

In an embodiment, measuring the liquid usage rate comprises: providing a means for measuring the quantity of the liquid in the system; providing a means for measuring time elapsed; measuring a first quantity of liquid in the system at a first time; measuring a second quantity of liquid in the system at a second time wherein the second time is before additional liquid is added to the system; and subtracting the second quantity of liquid from the first quantity of liquid, and then dividing by the time elapsed between the first time and the second time.

In an embodiment, measuring and modifying steps are performed automatically without human intervention.

This invention provides smart garden devices for a gardening or hydroponics system comprises: means for delivering a nutrient to a plant growing or a seed germinating into a plant in the gardening or hydroponics system at a nutrient delivery rate; and means for measuring the quantity of the nutrient in the system; and the smart garden device comprises: means for receiving electricity; means for sending to and/or receiving data from the gardening or hydroponics system; means for measuring time elapsed; means for calculating the nutrient usage rate by the gardening or hydroponics system; and means for modifying the nutrient delivery rate by a method utilizing the nutrient usage rate.

In an embodiment, the smart garden device for a gardening or hydroponics system further comprises one or more means selected from the group consisting of: means for delivering a liquid quality to the plant or seed at a liquid delivery rate; and means for delivering a photoradiation quality to the plant or seed at a photoradiation delivery rate; and the smart garden device further comprises one or more paired means selected from the group consisting of: means for modifying the liquid delivery rate or liquid quality by a method utilizing the nutrient usage rate; and means for modifying the photoradiation delivery rate or photoradiation quality by a method utilizing the nutrient usage rate. The means are preferably paired such that the means required in the system are selected as required for the means selected the device or vice versa.

This invention provides methods for growing a plant or germinating a seed into a plant comprising: providing the plant or the seed; providing a liquid having a liquid delivery quality; providing at least one plant nutrient having a plant nutrient quality; providing photoradiation having photoradiation quality; providing a means for measuring the nutrient usage rate; delivering the liquid to the plant at a liquid delivery rate; delivering the at least one plant nutrient at a plant nutrient delivery rate; delivering the photoradiation; measuring the nutrient usage rate of the plant; and modifying one or more characteristic selected from the group consisting of: liquid quality, liquid delivery rate, plant nutrient quality, plant nutrient delivery rate, photoradiation quality, and photoradiation delivery rate, by a method utilizing the nutrient usage rate.

In an embodiment, the measuring and modifying steps are performed automatically without human intervention. In an embodiment, the nutrient is dissolved in the liquid wherein the nutrient usage rate is the change in nutrient concentration in the liquid over time. In an embodiment, the change in nutrient concentration is measured by the change in electrical conductivity of the liquid over time. Preferably, a measurement of the rate of water usage is made constantly and automatically, without the need for human intervention each time that a measurement is taken and an adjustment is made.

Water usage can be measured by any method known in the art or as yet to be invented. Methods for automatically measuring water level include, but are not limited to, indirect methods using floats to trigger a magnetic reed switch (pulls magnets together), a proximity switch (blocking magnetic field), or a Hall-effect sensor (senses magnetic field and generates proportional signal), and direct methods using electrodes (detect current at water levels).

The embodiments of this invention are useful with both the devices and methods of this invention.

In an embodiment of this invention, the liquid usage rate of the nutrient usage rate correlates with and is predictive of the plant health, plant age, developmental stage, and/or maturity. In an embodiment, the devices and methods of this invention comprise means for measuring the temperature and humidity in which the plant is grown and utilizing these data to determine the appropriate liquid usage rate thresholds.

Optimum liquid usage rate thresholds and nutrient usage rate thresholds and liquid, nutrient, and photoradiation delivery regimes can be determined experimentally and utilized with the devices and methods of this invention.

In an embodiment, the device is preprogrammed with data regarding the typical liquid usage rate and/or nutrient usage rate for the type of plant to be grown.

The liquid usage rate for each plant type is affected by the type of plant growing system used and by the number of plants grown simultaneously.

In an embodiment, the characteristics of the device are modified utilizing data on both the liquid usage rate and the nutrient usage rate.

Plants grown using devices and methods of this invention are more healthy and productive than plants grown equivalently without using the methods and devices of this invention.

In an embodiment, the device is able to grow healthy, productive plants if the liquid usage rate and/or nutrient usage rate reach does not reach a minimum threshold for modifying a listed characteristic of the plant growing system.

In an embodiment, the device is also able to grow healthy, productive plants if the liquid usage rate is not measurable. For example, the liquid usage rate would might not be measurable if the liquid is delivered to the system by an external reservoir that adds a small amount of liquid to the system automatically when the third magnetic reed switch is activated whereby enough water is added to deactivate the third magnetic reed switch and active the second magnetic reed switch, but not enough to activate the first magnetic reed switch.

In an embodiment, a modification of the nutrient quality is a switch from grow nutrients to bloom nutrients, or an increase in the requirement to add nutrient rate of grow nutrients. Appropriate nutrient formulations and concentrations for selected plants and plant developmental stages are known in the art.

In an embodiment, modifying photoradiation quality comprises modifying the wavelengths of photoradiation delivered. In an embodiment, modifying photoradiation quality includes modifying the number of hours per day photoradiation is delivered and/or modifying the intensity of photoradiation delivered.

In an embodiment, the means for measuring the quantity of said liquid in the gardening or hydroponics system is in the smart garden device instead of the gardening or hydroponics system.

This invention provides a kit comprising a device of this invention and instructions for using the device. In an embodiment, liquid is delivered passively, by the growing medium in the seed cartridge wicking liquid from the vessel.

Look-up tables useful in the practice of this invention include tables having information on plant type, liquid usage rate, light/photoradiation delivery schedules, liquid delivery schedules, and nutrient indicator schedules, nutrient type schedules, and/or nutrient delivery schedules. An example of a look-up table for a 14.5 cup garden that is growing tomatoes is:

| Liquid | | | | | |
|---|---|---|---|---|---|
| Usage | | | Pump Flow | | |
| Rate | Lights | Pump On/Off Schedule | Rate | Nutrient Type | Nutrient Rate |
| <3 cups | on 24 hours | on 24 hours every 24 hours | 30 liters/hour | Small AeroGarden | two tablets every |
| per 7 | every 24 hours | (same hours as lights are on) | | Tablet | two weeks |
| days | | | | | |
| >=3 cups | on 20 hours | on 20 hours every 24 hours | 90 liters/hour | Small AeroGarden | one tablet every |
| per 7 | every 24 hours | (same hours as lights are on) | | Tablet | week |
| days | | | | | |
| >=3 cups | on 16 hours | on 22 hours every 24 hours (on | 150 liters/hour | Small and Large | one small and |
| per 3 | every 24 hours | all hours the lights are on) | | AeroGarden Tablets | one large tablet |
| days | | | | | every two weeks |
| >=3 cups | on 16 hours | on all 24 hours | 210 liters/hour | Large AeroGarden | two tablets every |
| per 1.5 | every 24 hours | | | Tablet | two weeks |
| days | | | | | |
| >=6 cups | on 16 hours | on all 24 hours | 270 liters/hour | Large AeroGarden | two tablets every |
| per 1 day | every 24 hours | | | Tablet | 10 days |

### EXAMPLE 1

Tomatoes are grown using the methods and devices of this invention. During germination and seedling growth, liquid comprising water and grow nutrients is delivered for half and hour and then not delivered for half an hour, repeatedly, grow nutrients are only added once at the beginning, and photoradiation is delivered for about 14 hours and then not for about 10 hours, repeatedly. After a liquid usage rate threshold is achieved, at about 2 weeks, liquid comprising water and bloom nutrients is delivered for about 45 minutes and then not for about 15 minutes, repeatedly, bloom nutrients are added about every 6-8 days, and photoradiation is delivered for about 16 hours and then not for about 8 hours, repeatedly. After a second liquid rate threshold is achieved, at about 4 weeks, liquid comprising water and bloom nutrients is delivered about constantly, bloom nutrients are added about every 6-8 days, and photoradiation is delivered for about 18 hours and then not for about 6 hours, repeatedly. The tomato plants grown using these methods produce more tomatoes, more quickly, and that are more tasty, than control tomatoes grown with grow and then bloom nutrients that are switched according to a similar (but not equivalent) predetermined schedule, and with liquid and photoradiation delivery that are also delivered according to a similar (but not equivalent) predetermined schedule. The control tomatoes are not grown using an equivalent scheme because it is precisely the devices and methods of this invention that allow the regimes to be exactly tailored to the individual plants needs, optimizing liquid, nutrient, and photoradiation delivery at all times.

Methods and devices useful in the practice of this invention can be found in the following applications:

| | | |
|---|---|---|
| | | Filing |
| Ser. No. | Title | Date |

| | | |
|---|---|---|
| 10/714,786 | Soil-Less Seed Support Medium and | 17, Nov. 2003 |
| | Method for Germinating a Seed | |
| PCT/ | Devices and Methods for Growing Plants | 15, Sep. 2004 |
| US04/30168 | | |
| 10/528,110 | Devices and Methods for Growing Plants | 15, Jul. 2005 |
| 11/112,269 | Devices and Methods for Growing Plants | 22, Apr. 2005 |
| 11/321,910 | Time-release, Oxygen-generating, and | 28, Dec. 2005 |
| | Effervescing Nutrient Compositions | |
| | and Methods for Growing Plants | |
| 11/321,023 | pH Buffered Plant Nutrient Compositions | 28, Dec. 2005 |
| | and Methods for Growing Plants | |
| 11/455,364 | Smart Garden Methods and Devices | 19, Jun. 2006 |
| | for Growing Plants | |
| 29/235,880 | Indoor Gardening Appliance | 8, Aug. 2005 |
| 11/895,972 | Master Gardener Baskets and Methods for | 28, Aug. 2007 |
| | Growing Plants | |
| 11/653,121 | Devices and Methods for Growing Plants | 12, Jan. 2007 |
| 29/271,260 | Indoor Gardening Appliance | 12, Jan. 2007 |
| 29/271,209 | Indoor Gardening Appliance | 12, Jan. 2007 |
| 29/271,259 | Indoor Gardening Appliance | 12, Jan. 2007 |
| 11/654,164 | Systems and Methods for Controlling | 16, Jan. 2007 |
| | Liquid Delivery and Distribution to Plants | |

In an embodiment, the smart garden device is enclosed within the hydroponics or gardening system. Garden components useful in the practice of this invention are available from AeroGrow (Boulder, Colo.).

Although this invention has been described with respect to specific embodiments, it is not intended to be limited thereto, and various modifications which will become apparent to the person of ordinary skill in the art are intended to fall within the scope of the invention as described herein. The embodiments of this invention are useful individually and in combination.

All references cited are incorporated herein by reference to the extent that they are not inconsistent with the disclosure herein.

1. A hydroponic or aeroponic garden apparatus, comprising:
a) a vessel having a closed lower portion for storing a liquid;
b) a growing surface covering the vessel, the growing surface adapted to support at least one seed cartridge containing a seed or a plant;
c) a light source positioned above the growing surface and adapted to project light toward the seed cartridge;
d) a measurement device first component float located in the vessel and a second component linear hall effect sensor near said float adapted to measure the level of the liquid;
e) a microprocessor controller in communication with the measurement device, the controller adapted to calculate a rate of consumption of the liquid in the vessel, and perform at least one predetermined function based on the rate of consumption, wherein the at least one predetermined function selected from the group consisting of: adjusting a timing cycle of the light source; adding a nutrient to the liquid; and triggering an add-nutrient indicator indicating a type and/or amount of nutrient to add,
f) an eeprom memory in communication with the controller,
g) a timer, wherein the controller is adapted to calculate the rate of consumption based on data from the timer and the measurement device,
h) a look-up table stored in the memory, wherein the controller determines which predetermined function to perform by comparing the calculated rate of consumption to the look-up table, and
i) a pump adapted to deliver the liquid from the vessel to the at least one seed cartridge, wherein the controller is adapted to adjust a flow rate of the pump based on the rate of consumption.

2. A hydroponic or aeroponic garden apparatus, comprising:
a) a vessel having a closed lower portion for storing a liquid;
b) a growing surface covering the vessel, the growing surface adapted to support at least one seed cartridge containing a seed or a plant;
c) a light source positioned above the growing surface and adapted to project light toward the seed cartridge;
d) a measurement device located in the vessel and adapted to measure the level of the liquid; and
e) a controller in communication with the measurement device, the controller adapted to calculate a rate of consumption of the liquid in the vessel, and perform at least one predetermined function based on the rate of consumption,
wherein the at least one predetermined function selected from the group consisting of: adjusting a timing cycle of the light source; adding a nutrient to the liquid; and triggering an add-nutrient indicator.

3. The apparatus of claim 2, further comprising: a pump adapted to deliver the liquid from the vessel to the at least one seed cartridge, wherein the controller is adapted to adjust a flow rate of the pump based on the rate of consumption.

4. The apparatus of claim 2, wherein the add-nutrient indicator indicates a type and/or amount of nutrient to add.

5. The apparatus of claim 2, wherein the measurement device is selected from the group consisting of: linear hall effect sensor, a plurality of hall effect sensors, a float connected to a mechanical encoder, a float connected to an optical encoder, an infrared device, a plurality of pairs of a magnetic floatation device and magnetic reed switch.

6. The apparatus of claim 2, further comprising a memory in communication with the controller.

7. The apparatus of claim 6, wherein the memory is selected from the group consisting of: an electrically erasable programmable read-only memory, electrically programmable read-only memory, flash memory, microcontroller built-in memory.

8. The apparatus of claim 6, further comprising a look-up table stored in the memory, wherein the controller determines which predetermined function to perform by comparing the calculated rate of consumption to the look-up table.

9. The apparatus of claim 2, further comprising an algorithm programmed into the controller, wherein the controller determines which predetermined function to perform by applying the algorithm to the calculated rate of consumption.

10. The apparatus of claim 1, further comprising a timer, wherein the controller is adapted to calculate the rate of consumption based on data from the timer and the measurement device.

11. A method of growing a plant or germinating a seed in a hydroponic or aeroponic garden apparatus, comprising:
a) delivering a liquid to the plant or seed at a liquid delivery rate, the liquid exhibiting a liquid quality;
b) delivering a nutrient to the plant or seed at a nutrient delivery rate, the nutrient exhibiting a nutrient quality;
c) delivering photoradiation to the plant or seed at a photoradiation delivery rate, the photoradiation exhibiting a photoradiation quality;
d) calculating a rate of liquid usage by the plant or seed in the hydroponic or aeroponic garden apparatus; and
e) adjusting at least one of the liquid delivery rate, the liquid quality, the nutrient delivery rate, the nutrient quality, the photoradiation delivery rate, and the photoradiation quality based on the calculated rate of liquid usage.

12. The method of claim 11, wherein calculating the rate of liquid usage by the plant or seed comprises:
a) measuring a first liquid level in the hydroponic or aeroponic garden apparatus at a first time point;
b) measuring a second liquid level in the hydroponic or aeroponic garden apparatus at a second time point;
c) calculating an elapsed time between the first time point and the second time point;
d) calculating an amount of consumed liquid by subtracting the first liquid level from the second liquid level; and
e) dividing the amount of consumed liquid by the elapsed time.

13. The method of claim 11, further comprising comparing the rate of liquid usage to a look-up table.

15. The method of claim 11, wherein delivering the liquid to the plant or seed comprises pumping the liquid from a storage vessel to the plant or seed.

16. The method of claim 11, wherein adjusting the liquid delivery rate comprises at least one of increasing the liquid delivery rate, decreasing the liquid delivery rate, increasing flow rate of said liquid, decreasing a flow rate of said liquid, increasing the on/off ratio wherein said liquid is delivered intermittently, decreasing the on/off ratio wherein said liquid is delivered intermittently, switching from continuous to intermittent delivery of said liquid, switching from intermittent to continuous delivery of said liquid, and increasing from on for less than or about 15 hours of every 24 hours to on for more than or about 17 hours of every 24 hours.

17. The method of claim 11, wherein adjusting the nutrient delivery rate comprises at least one of decreasing the time between intermittently adding a nutrient molecule or atom to said liquid, increasing the time between intermittently adding a nutrient molecule or atom to said liquid, increasing from about 1.5 grams complete nutrient for about every 14 cups every 2 weeks to about 3 grams complete nutrient for about every 14 cups every 2 weeks.

18. The method of claim 11, wherein adjusting the nutrient quality comprises at least one of decreasing a nutrient atom or molecule, increasing a nutrient atom or molecule, adding a new nutrient or molecule, removing a nutrient or molecule, increasing calcium, increasing magnesium, decreasing nitrogen, increasing nitrogen, increasing potassium, increasing phosphorus, and modifying the nitrogen/phosphorus/potassium ratio.

19. The method of claim 11, wherein adjusting the photoradiation rate comprises at least one of increasing the on/off ratio wherein said photoradiation is delivered intermittently, decreasing the on/off ratio wherein said photoradiation is delivered intermittently, increasing the distance between said seed or plant and said bulb, and decreasing the distance between said seed or plant and said bulb.

20. The method of claim 11, wherein steps (d) and (e) are performed automatically without human intervention.
